(19) United States
(12) Patent Application Publication
(10) Pub. No.: US 2023/0057595 A1
(43) Pub. Date: Feb. 23, 2023

(54) BATTERY ARRANGEMENT

(71) Applicant: Dr. Ing. h.c. F. Porsche Aktiengesellschaft, Stuttgart (DE)

(72) Inventors: Immanuel Vogel, Steinheim (DE); Christopher Volkmer, Niefern-Oschelbronn (DE); Philipp Kellner, Renningen (DE); Sascha Mostofi, Stuttgart (DE); Ralf Keller, Pforzheim (DE)

(73) Assignee: Dr. Ing. h.c. F. Porsche Aktiengesellschaft, Stuttgart (DE)

(21) Appl. No.: 17/857,351

(22) Filed: Jul. 5, 2022

(30) Foreign Application Priority Data
Aug. 18, 2021 (DE) 10 2021 121 397.5

(51) Int. Cl. H01M 10/658; H01M 50/204; H01M 50/249; H01M 50/289; H01M 50/593; H01M 10/625

(52) U.S. Cl. CPC H01M 10/658; H01M 50/204; H01M 50/249; H01M 50/289; H01M 50/593; H01M 10/625; H01M 2220/20

(57) ABSTRACT

A battery arrangement has at least two battery modules each having a battery module housing. Each battery module housing has at least two chambers separated from one another by a dividing wall, in which chambers in each case at least one cell stack is disposed. The cell stack has at least two stacked battery cells and at least one compression pad. A thermal insulation layer is provided in each case between the dividing wall and the adjacent battery cells. The distance between the dividing wall and a battery cell adjacent to the dividing wall of a predefined first cell stack is at least twice as great as the distance between two adjacent battery cells within the predefined first cell stack.

### CROSS-REFERENCE TO RELATED APPLICATION

This application claims priority to German Patent Application No. 10 2021 121 397.5, filed Aug. 18, 2021, the content of such application being incorporated by reference herein in its entirety.

### FIELD OF THE INVENTION

The invention relates to a battery arrangement and to a vehicle.

### BACKGROUND OF THE INVENTION

DE 10 2019 105 810 A1, which is incorporated by reference herein, shows a battery module having battery cells which are divided into segments, wherein a thermally activatable protective device is provided which increases the distance between the segments in the event of a thermal incident.

DE 10 2017 218 250 A1, which is incorporated by reference herein, shows a battery module having battery cell stacks between which a cooling plate serving as a compression pad is arranged.

EP 3 540 812 A1, which is incorporated by reference herein, shows a battery having two or more stacked battery cells, in which an element is provided on an outermost battery cell which absorbs the change in length in the event of a battery cell swelling.

EP 3 268 999 B1, which is incorporated by reference herein, shows a battery module having battery cells between which a separator plate is provided.

### SUMMARY OF THE INVENTION

A battery arrangement comprises at least two battery modules, which battery modules each have a battery module housing, which battery module housing has at least two chambers separated from one another by a dividing wall, in which chambers in each case at least one cell stack is provided, which cell stack has at least two stacked battery cells and at least one compression pad, wherein a thermal insulation layer is provided in each case between the dividing wall and the adjacent battery cells, and wherein the distance between the dividing wall and a battery cell adjacent to the dividing wall of a predefined first cell stack is at least twice as great as the distance between two adjacent battery cells within the predefined first cell stack. This design reduces the risk of a thermal event spreading throughout the entire battery arrangement and therefore significantly increases the safety of the vehicle occupants.

According to a preferred embodiment, the thermal insulation layer comprises at least one material from the group of materials consisting of

steel,

glass fiber-reinforced plastic,

composite material,

ceramic,

aerogel,

fire retardant fleece, and

metal-plastic composite system.

These are highly suitable materials for thermal insulation and they also allow for good mechanical protection.

According to a preferred embodiment, the cell stack comprises a cell stack housing, and the thermal insulation layer is integrated into the cell stack housing. This reduces the risk of thermal propagation and simplifies the assembly.

According to a preferred embodiment, the thermal insulation layer is firmly bonded to the battery module housing. In this embodiment, no thermal insulation layer needs to be positioned individually when positioning the cell stack.

According to a preferred embodiment, the thermal insulation layer is designed as an electrical insulator and is arranged to prevent current flow between the dividing wall and the adjacent battery cell. This prevents or reduces propagation in particular in the case of a thermal event.

According to a preferred embodiment, a flat component is provided between the thermal insulation layer and the dividing wall to facilitate insertion of the cell stack into one of the chambers. The flat component allows the cell stack to slide more easily into the chamber.

According to a preferred embodiment, the flat component comprises glass fiber-reinforced plastic. This material is stable and has a comparatively low coefficient of friction.

According to a preferred embodiment, a compression pad is provided in each case between the dividing wall and the adjacent battery cells. The compression pad additionally protects the adjacent battery cells.

According to a preferred embodiment, a compression pad is provided in each case between the battery cells of the cell stack. Compensation of a volume change in the battery cells is thus readily possible and the compression pads at least slow down the propagation of a thermal event.

According to a preferred embodiment, the battery module housing has at least one extrusion profile with the at least two chambers and the at least one dividing wall. The use of an extrusion profile increased stability.

According to a preferred embodiment, at least two cell stacks are provided in at least one of the chambers. This can increase the energy density in the battery arrangement since the number of walls is reduced.

According to a preferred embodiment, an adhesive bond is provided between the compression pads and at least one adjacent battery cell. Adhesive bonds reliably secure the position relative to each other and thereby improve the battery arrangement.

According to a preferred embodiment, the battery module housings are each of a sealed design. The risk of grime entering or gases escaping is reduced.

According to a preferred embodiment, the battery modules are spaced apart from each other. The spacing reduces the risk of a propagation across battery modules.

A vehicle has such a battery arrangement and an electric motor. The electric motor can be operated with the aid of the electrical energy of the battery arrangement, and the occupants are well protected by the battery arrangement.

### BRIEF DESCRIPTION OF THE DRAWINGS

Further details and advantageous developments of the invention will emerge from the exemplary embodiments described below and illustrated in the drawings, which exemplary embodiments should in no way be understood as restricting the invention, and also from the dependent claims. It is understood that the features mentioned above and the features yet to be discussed below may be used not only in the respectively specified combination but also in other combinations or individually without departing from the scope of the present invention. In the figures:

FIG. 1 shows a schematic representation of a battery arrangement with chambers and cell stacks,

FIG. 2 shows a cell stack of the battery arrangement of FIG. 1,

FIG. 3 shows a schematic top view of a battery module of the battery arrangement of FIG. 1,

FIG. 4 shows a battery cell with a compression pad,

FIG. 5 shows an embodiment of a battery module of FIG. 1 in schematic cross-section,

FIG. 6 shows a further embodiment of the battery module of FIG. 1 in schematic cross-section,

FIG. 7 shows a vehicle with the battery module of FIG. 1.

### DETAILED DESCRIPTION OF THE INVENTION

Identical or functionally identical parts are provided with the same reference signs below and are usually described only once. The description spans the figures such that these build on one another, in order to avoid unnecessary repetitions.

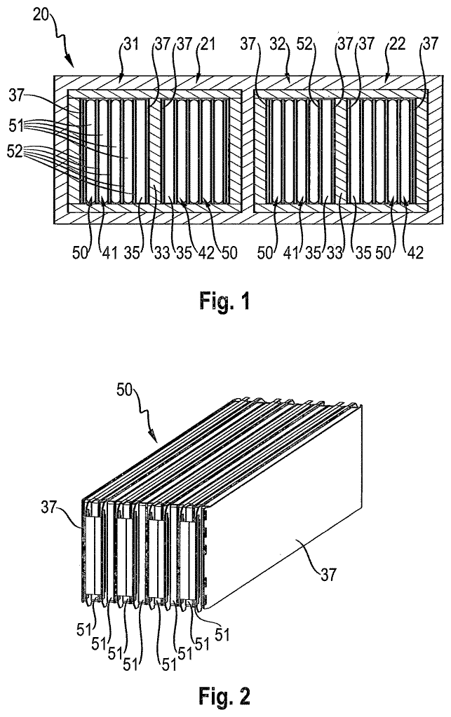

FIG. 1 shows a schematic top view of a battery arrangement 20. The battery arrangement 20 has two battery modules 21, 22, which battery modules 21, 22 each having a battery module housing 31, 32. The battery module housings 31, 32 are preferably connected to each other, but they may also be separate. The battery module housings 31, 32 comprise at least two chambers 41, 42 separated from one another by a dividing wall 33. In each case at least one cell stack 50 is provided in the chambers 41, 42, which cell stack 50 comprises at least two stacked battery cells 51 and at least one compression pad 52. In the exemplary embodiment, each cell stack 50 consists of four battery cells 51, but there may also be, for example, five or eight battery cells 51 in the cell stack 50. A thermal insulation layer 35, which may also be referred to as a thermal insulation element 35, is provided between the dividing wall 33 and the adjacent battery cells 51.

The thermal insulation layer 35 preferably comprises at least one material from the group of materials consisting of:

steel,

glass fiber-reinforced plastic,

composite material,

ceramic,

aerogel,

fire retardant fleece, and

metal-plastic composite system.

Steel is comparatively heat-stable and, together with other thermal insulating materials, a heat-stable and thermally insulating thermal insulation layer 35 can be produced.

Glass fiber-reinforced plastics are highly stable and enable good thermal insulation.

Composite materials combine the properties of different materials in an advantageous manner and can be designed to be both heat-stable and thermally insulating.

Ceramic is very heat-stable and enables thermal insulation.

Aerogels are highly porous solids having many pores which are produced, for example, based on silicate. They are highly suitable for thermal insulation.

Fire retardant fleece has been developed for fire protection and enables good thermal shielding.

Metal-plastic composite systems as hybrid components also enable a heat-stable thermally insulating material combination.

The thermal insulation layer 35 can be firmly bonded to the battery module housing 31, 32, to allow good positioning.

The thermal insulation layer 35 is preferably designed as an electrical insulator and is arranged to prevent current flow between the dividing wall 33 and the adjacent battery cell 51. In this case, the entire dividing wall 33 does not have to be electrically insulating, but there must not be any electrically conductive conductor bridges that pass through.

Preferably, flat components 37 are provided in each case between the dividing wall 33 and the thermal insulation layer 35, which facilitate insertion of the cell stack 50 into the chamber 41 or 42. The flat component 37 preferably allows a low coefficient of friction in interaction with the dividing wall 33, and it preferably has a solid shape to facilitate insertion. A highly suitable material for the flat component 37 is, for example, glass fiber-reinforced plastic. This also enables electrical insulation and additional thermal insulation.

In the exemplary embodiment, a compression pad 52 is provided between the dividing wall 33 and the adjacent battery cells 51. The compression pad 52 is preferably provided on the adjacent battery cell 51, but it may also be provided between the thermal insulation layer 35 and the dividing wall 33. In the exemplary embodiment, a compression pad 52 is provided between each of the battery cells 51 of the cell stack 50. Alternatively, a compression pad 52 may be provided only for some of the battery cells 51.

The battery module housing 31, 32 preferably has at least one extrusion profile with the at least two chambers 41, 42 and the at least one dividing wall 33. Extrusion profiles are comparatively stable and simple to produce. The open sides of the extrusion profile may be sealed by appropriate covers.

The battery module housings 31 and 32 are preferably each of a sealed design. This can prevent or at least very greatly reduce leakage of fluid or entry of grime.

The dividing walls 33 are also preferably of a sealed design to the extent that they separate the two chambers 41, 42 from each other in an airtight manner. However, the dividing wall 33 may alternatively be of a non-sealed design, wherein it preferably covers at least the region directly between the adjacent battery cells 51 on the two sides of the dividing wall 33.

The battery modules 21, 22 are preferably spaced apart from each other.

In battery arrangements, a thermal event may occur, for example, in the event of a defect in a battery cell 51 or in the case of an accident. In such a thermal event, there may be a strong local build-up of heat. In practice, the problem is that high temperatures can arise in a damaged battery cell 51 due to chemical reactions and because of the high energy density, and this can also damage adjacent battery cells and lead to a further increase in temperature. This is referred to as thermal runaway. Therefore, the initially local heat generation should preferably be kept local as completely as possible or at least for a relatively long period of time.

The compression pads 52 serve to compensate for volume expansion or volume reduction of the battery cells 51 that occur during operation of the battery arrangement 20, without adversely affecting the external geometry of the battery module 21 or 22. These volume changes are caused, for example, by the swelling effect. They thereby maintain compression of the battery cells 51. For this purpose, the compression pads 52 are compressible, i.e. they can be compressed. Suitable materials for the compression pads are, for example, polyurethane, silicone foam and/or neoprene-based foams. Another advantage of the compression pads 52 is that they reduce heat transfer and result in a certain level of thermal insulation. This reduces propagation between adjacent battery cells 51 within the cell stack 50.

In addition, the dividing wall 33 and the thermal insulation layers 35 greatly reduce heat transfer between the different chambers 41, 42, and the risk of propagation from one chamber 41 to the adjacent chamber 42 is greatly reduced. In addition, the battery modules 21, 22 are preferably spaced apart from each other and thereby propagation from module 21 to module 22 or vice versa is prevented or at least very unlikely.

These measures lead to a significant improvement in the protection of vehicle occupants, as the number of cells affected and thus the amount of energy released can be effectively limited.

FIG. 2 shows a cell stack 50 with battery cells 51 and the flat component 37. This cell stack 50 can be slid in its entirety into one of the chambers 41, 42 during assembly.

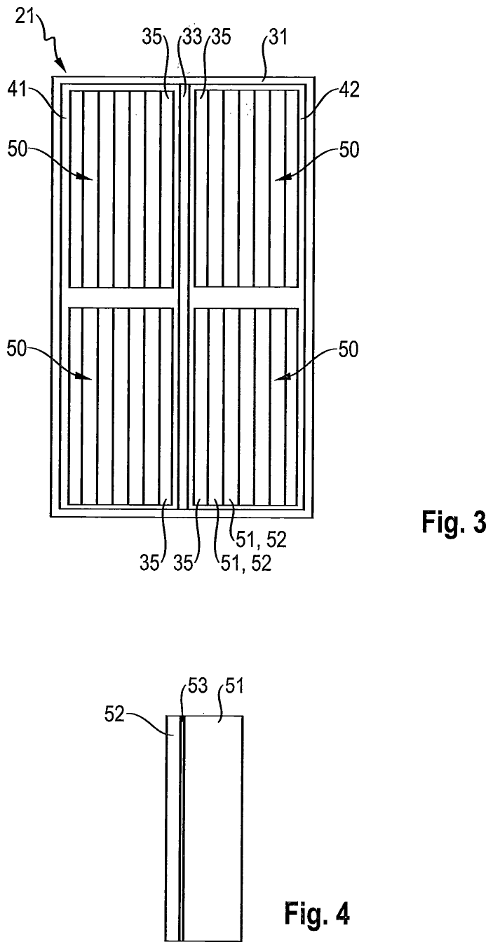

FIG. 3 shows the battery module 21 with the battery module housing 31 and the dividing wall 33. In this exemplary embodiment, in each case two cell stacks 50 are provided in the two chambers 41, 42. This arrangement of two or more cell stacks 50 in the chambers 41, 42 can save space and weight.

The two cell stacks 50 of the respective chambers 41 or 42 are preferably arranged adjacent to each other at the end faces, since heat transfer in this area is less than at the extended sides of the battery cells 51, the orientation of which is indicated schematically. In other words, the cell stacks 50 are preferably arranged on the dividing wall 33 such that the battery cells 51 run parallel to the dividing wall 33.

FIG. 4 shows one of the battery cells 51 and an adjacent compression pad 52. The compression pad 52 is attached to the battery cell 51 by an adhesive bond 53. This facilitates stacking the battery cells 51 into a cell stack 50.

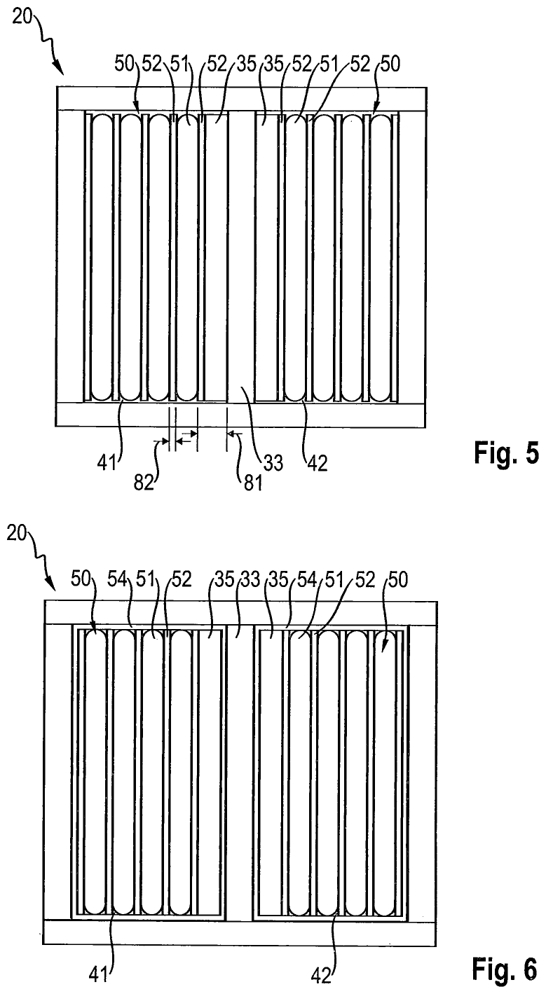

FIG. 5 shows a cross-section through an embodiment of the battery module of the battery arrangement 20. The cell stacks 50 are provided in the associated chambers 41, 42. The distance 81 refers to the distance between the dividing wall 33 and the battery cell 51 adjacent to the dividing wall 33 of the predefined first cell stack 50, and the distance 82 refers to the distance between two adjacent battery cells 51 within the predefined first cell stack 50. The distance 81 is at least twice as great as the distance 82, and this can result in good insulation in the region 81. The factor 2 as minimum results in a good compromise between the highest possible energy density on the one hand and great safety on the other.

FIG. 6 shows a cross-section through another embodiment of the battery module of the battery arrangement 20. Unlike the embodiment of FIG. 5, a cell stack housing 54 is additionally provided around each cell stack 50. The thermal insulation layer 35 is preferably integrated into or arranged in the cell stack housing 54. This enables easy assembly and a high degree of automation, and thermal separation of the cell stacks 50 from each other is further improved.

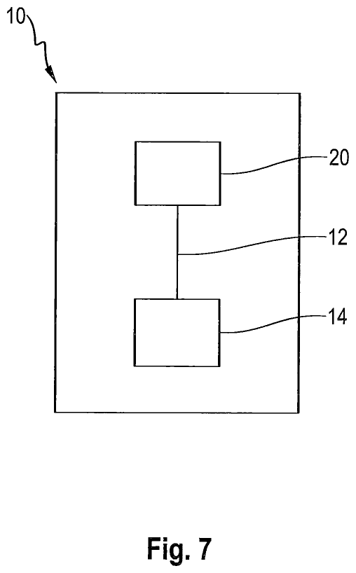

FIG. 7 shows, in a schematic representation, a vehicle 10 having the battery arrangement 20 and an electric motor 14. By way of example, the battery arrangement 20 and the electric motor 14 are connected electrically to each other via an electric cable 12. By providing the battery arrangement 20, occupant protection is greatly increased, and this is of particular relevance in vehicles 10.

Numerous variations and modifications are of course possible within the scope of the present invention.

What is claimed is:

1. A battery arrangement comprising:
at least two battery modules each having a battery module housing, each battery module housing having at least two chambers separated from one another by a dividing wall,
at least one cell stack disposed in each chamber, each cell stack having at least two stacked battery cells and at least one compression pad, and
a thermal insulation layer disposed in each chamber between the dividing wall and the adjacent battery cells,
wherein a distance between the dividing wall and a battery cell adjacent to the dividing wall of a first cell stack is at least twice as great as a distance between two adjacent battery cells within the first cell stack.

2. The battery arrangement as claimed in claim 1, in which the thermal insulation layer comprises at least one material from the material group consisting of
steel,
glass fiber-reinforced plastic,
composite material,
ceramic,
aerogel,
fire retardant fleece, and
metal-plastic composite system.

3. The battery arrangement as claimed in claim 1, wherein the cell stack comprises a cell stack housing, and wherein the thermal insulation layer is integrated into the cell stack housing.

4. The battery arrangement as claimed in claim 1, wherein the thermal insulation layer is bonded to the battery module housing.

5. The battery arrangement as claimed in claim 1, wherein the thermal insulation layer is an electrical insulator that is configured to prevent current flow between the dividing wall and the adjacent battery cell.

6. The battery arrangement as claimed in claim 1, further comprising a flat component disposed between the thermal insulation layer and the dividing wall in order to facilitate insertion of the cell stack into one of the chambers.

7. The battery arrangement as claimed in in claim 1, wherein the compression pad is disposed between the dividing wall and the adjacent battery cells.

8. The battery arrangement as claimed in claim 7, wherein the compression pad is disposed, in each case, between the battery cells of the cell stack.

9. The battery arrangement as claimed in claim 1, wherein the battery module housing has at least one extrusion profile including the at least two chambers and the at least one dividing wall.

10. The battery arrangement as claimed in claim 1, wherein at least two cell stacks are disposed in at least one of the chambers.

11. The battery arrangement as claimed in claim 1, further comprising an adhesive bond between the compression pads and at least one adjacent battery cell.

12. The battery arrangement as claimed in claim 1, wherein each battery module housing is sealed.

13. The battery arrangement as claimed in claim 1, wherein the battery modules are spaced apart from each other.

14. The battery arrangement as claimed in claim 1, further comprising a flat component disposed between the thermal insulation layer and the dividing wall in order to facilitate insertion of the cell stack into one of the chambers, and wherein the flat component comprises glass fiber-reinforced plastic.

15. A vehicle comprising the battery arrangement as claimed in claim 1 and an electric motor.
